(19) United States
(12) Patent Application Publication
(10) Pub. No.: US 2013/0054772 A1
(43) Pub. Date: Feb. 28, 2013

(54) METHOD AND APPARATUS FOR CONTENT MANAGEMENT USING NETWORK SERVER

(71) Applicants: Joo Il SUNG, Seoul (KR); Han Kyung JEON, Seongnam-si (KR); Chan Su AHN, Seoul (KR); Young Il OH, Gwacheon-si (KR); Je Sang YOON, Suwon-si (KR)

(72) Inventors: Joo Il SUNG, Seoul (KR); Han Kyung JEON, Seongnam-si (KR); Chan Su AHN, Seoul (KR); Young Il OH, Gwacheon-si (KR); Je Sang YOON, Suwon-si (KR)

(73) Assignee: SAMSUNG ELECTRONICS CO. LTD., Suwon-si (KR)

(21) Appl. No.: 13/455,514

(22) Filed: Apr. 25, 2012

(30) Foreign Application Priority Data
Aug. 24, 2011 (KR) 10-2011-0084383

(51) Int. Cl. G06F 15/173

(52) U.S. Cl. 709/223

(57) ABSTRACT

A method and apparatus for content management using a network server are provided. The method for content management includes producing a basis data package, producing a modified data package, and producing a data package list. The method and apparatus set a sharing scheme adequate for the purpose of specific content and to manage content modification activities.

### PRIORITY

This application claims the benefit under 35 U.S.C. §119(a) of a Korean patent application filed on Aug. 24, 2011 in the Korean Intellectual Property Office and assigned Serial No. 10-2011-0084383, the entire disclosure of which is hereby incorporated by reference.

### BACKGROUND OF THE INVENTION

1. Field of the Invention

The present invention relates to a method and apparatus for content management using a network server. More particularly, the present invention relates to a method and apparatus that manage sharing of content on a network.

2. Description of the Related Art

Content sharing on a network may be accomplished through a process of a producer initially uploading created content and many others (e.g., consumers) viewing, downloading, or otherwise consuming the content. After downloading the content, the users may modify the content without restrictions. This may be verified by the number of hits and comments.

However, when content is propagated according to the framework discussed above, the producer is unable to determine whether the content is utilized adequately for its intended purpose, by whom the content is shared, and how the content is modified. Therefore, performing content management and tracking the source of the content is very difficult.

Accordingly, it is necessary to develop a method and apparatus that set a sharing scheme adequate for the purpose of content and manage content modification activities.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for content management using a network server.

In accordance with an aspect of the present invention, a method for content management using a network server is provided. The method includes producing a basis data package by creating basis content in response to a creation request from a creator and generating basis metadata describing the basis content, producing a modified data package by creating modified content utilizing the basis content as a source in response to a modification request from a modifier and generating modified metadata describing the modified content, and producing a data package list by combining the basis data package and the modified data package.

In accordance with another aspect of the present invention, an apparatus for content management having a network server is provided. The apparatus includes a communication unit for receiving creation requests and modification requests from multiple devices and for sending requested content, a control unit for producing basis content, base metadata, modified content, and modified metadata, and for generating a data package list by combining the basis content, base metadata, modified content, and modified metadata, and a storage unit for storing the basis content, base metadata, modified content, modified metadata and data package list.

In accordance with aspects of the present invention, the producer or network server may determine a content sharing scheme.

Additionally, content modification activities may be managed in various ways in terms of device identity, device location, device type, content creation time, number of modifications, source content, and modified content type.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a system for content management according to an exemplary embodiment of the present invention;

FIG. 2 is a block diagram of a network server in a system for content management according to an exemplary embodiment of the present invention;

FIG. 3A is a flowchart of a method for content management according to an exemplary embodiment of the present invention;

FIG. 3B is a flowchart of a procedure for utilizing a data package list in relation to a method for content management such as, for example, the method illustrated in FIG. 3A according to an exemplary embodiment of the present invention;

FIG. 4A illustrates appointment of modifiers in a one-to-one manner according to an exemplary embodiment of the present invention;

FIG. 4B illustrates appointment of modifiers in a one-to-many manner according to an exemplary embodiment of the present invention;

FIG. 5 illustrates generation of a basis data package, modified data package, and data package list according to an exemplary embodiment of the present invention; and

FIG. 6 illustrates a generated data package list according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description, “content” refers to generic digital data usable by a network server. For example, content may be digital data corresponding to text, symbols, voices, sounds, images, video, and/or the like. Content may be created by a device. “Basis content” is content that is shared by the producer and a modifier. Basis content corresponds to a source product of a content sharing process. “Modified content” is content that a modifier derives from basis content. In other words, basis content may form a basis from which a modifier may derive (e.g., modify so as to form) modified content. Modified content corresponds to an intermediate product of a content sharing process. Distinction between source content and modified content is made by, for example, differences between metadata of the source content and that of the modified content (not by modifications made to the source content).

Basis content does not necessarily refer to initially created content. That is, when modified content is produced by a first modifier on the basis of specific basis content, the modified content may be used by a second modifier as basis content. For example, any modified content may be the basis content to which subsequent modifications or derivations may be made to form modified content.

“Metadata” refers to incidental data generated while corresponding contents is generated. Metadata may be data that is descriptive of the generated content. For example, metadata for specific content may be descriptive data that is information regarding device identifier, device location, device type, content creation time, number of modifications, source content, and content type. Metadata may be generated while corresponding content is generated. Metadata may also be generated after the content is generated.

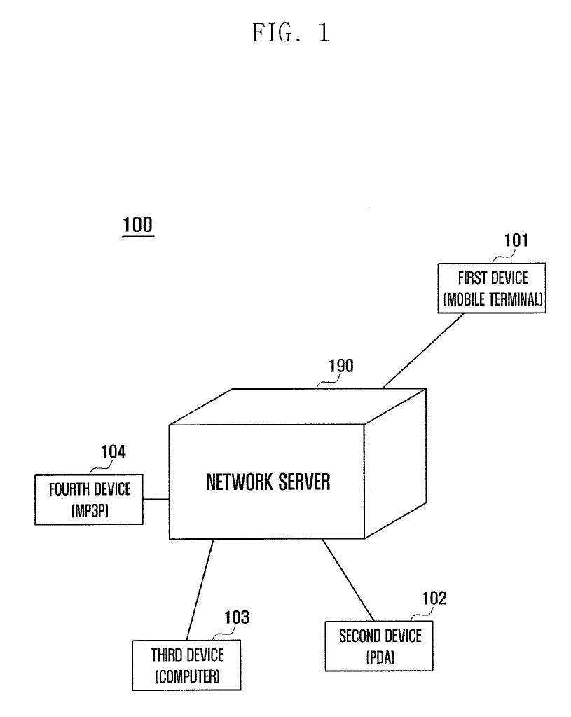

FIG. 1 is a block diagram of a system for content management according to an exemplary embodiment of the present invention.

Referring to FIG. 1, in the content management system 100, multiple devices 101 to 104 are interconnected through a network server 190. The devices 101 to 104 are devices that may share content through the network server 190. For example, the devices may be a mobile terminal, a PDA, computer, an MP3 player, and the like. The devices 101 to 104 may be linked with the network server 190 through wired or wireless connections. Although four devices are connected with the network server 190 in FIG. 1, any number of devices may be connected with the network server 190.

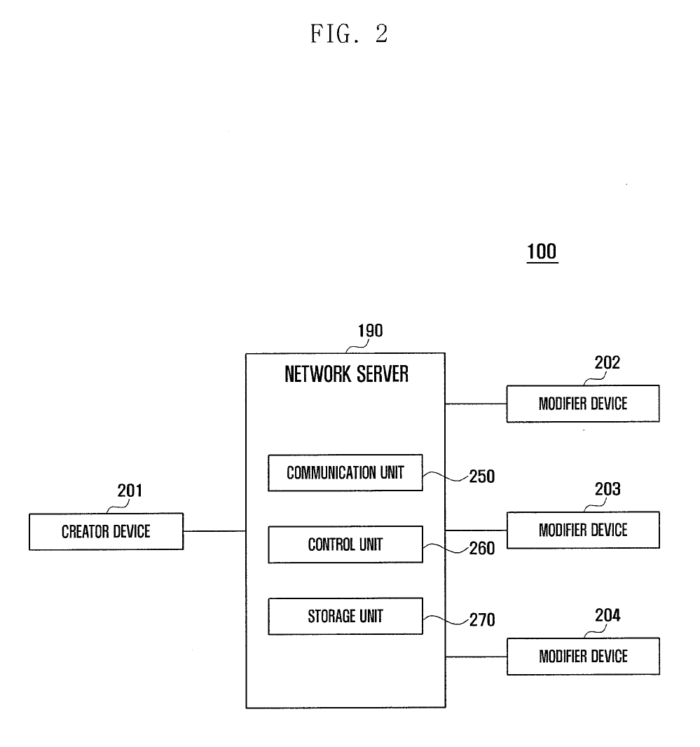

The network server 190 may receive a content creation request from any of the first to fourth devices 101 to 104. For example, the first device 101 (e.g., a mobile terminal) may send a content creation request to the network server 190 to upload a photograph taken by a camera module. In response to the reception of the content creation request, the network server 190 may create and store corresponding content. This content may become basis content. During creation of basis content, the network server 190 automatically creates descriptive data including identification information (including an IP address) of the first device 101, location information of the first device 101, device type of the first device 101, and content creation time. Such descriptive data is metadata for the content. The configuration of the network server 190 is described in detail with reference to FIG. 2.

FIG. 2 is a block diagram of a network server 190 in a system for content management such as, for example, the system for content management illustrated in FIG. 1 according to an exemplary embodiment of the present invention.

Referring to FIG. 2, the network server 190 includes a communication unit 250, a control unit 260, and a storage unit 270. As illustrated in FIG. 2, one of multiple devices connected to the network server 190 is referred to as a creator device 201, and the remaining devices are referred to as modifier devices 202 to 204. For example, when a first device issues a creation request for basis content and second to fourth devices issue a modification request to utilize the basis content as a source, the first device becomes a creator device and the second to fourth devices become modifier devices. The roles of a creator device and a modifier device are not fixed but are dynamic and are relative based on its respective relationship to the content and/or to other devices. For example, assume that content created by a first device is modified by a second device and the modification result is further modified by a third device. In such an example, the second device is a modifier device as to the first device, but is a creator device as to the third device.

The communication unit 250 receives a creation request or a modification request for content from a device and may transmit requested content to the device. The control unit 260 creates content according to the request received through the communication unit 250 and automatically generates metadata for the content. The storage unit 270 stores content and associated metadata created by the control unit 260.

For example, assume that a user A utilizing a notebook computer wishes to upload a created text and image file to A's blog. The notebook computer as a creator device 201 sends a content creation request for text and image content to the communication unit 250 of the network server 190 providing blogging services. The control unit 260 creates text and image content as basis content in response to the content creation request. In addition, the control unit 260 automatically generates descriptive data (i.e., metadata) including identification information (e.g., user A ID, notebook IP address), location information of the notebook, device type (e.g., notebook), and content creation time. This is to manage content sharing activities on the network. The basis content and associated metadata are saved as a basis data package in the storage unit 270.

Further, assume that a user B utilizing a smartphone wishes to copy the text part of A's blog and upload the copied text to B's blog. If the user B is selected as a modifier, then the network server 190 may send the basis content stored in the storage unit 270 through the communication unit 250 to the smartphone so that the user B may read and modify the basis content. Selection of a modifier device is described later. The smartphone as a modifier device 202 sends a modification request, for utilizing only the text part of the basis content as content, to the network server 190. Upon reception of the modification request through the communication unit 250, the control unit 260 creates modified content from the text part of the basis content (i.e., a source). In addition, the control unit 260 automatically generates descriptive data (i.e., metadata) including identification information (e.g., user B ID, smartphone IP address), location information of the smartphone, device type (e.g., smartphone), content creation time, source (e.g., basis content), and content type (e.g., text). The modified content and associated metadata are saved in the storage unit 270 as a modified data package.

In some exemplary embodiments of the present invention, the extent to which a modifier device may modify basis content may be set by using permissions. For example, the control unit 260 may define or otherwise establish a scope of modifications which the modifier device may perform on the basis content. As another example, various modifier devices may have varying scopes of permissions thus enabling some modifier devices to modify the basis content to a greater extent than other modifier devices.

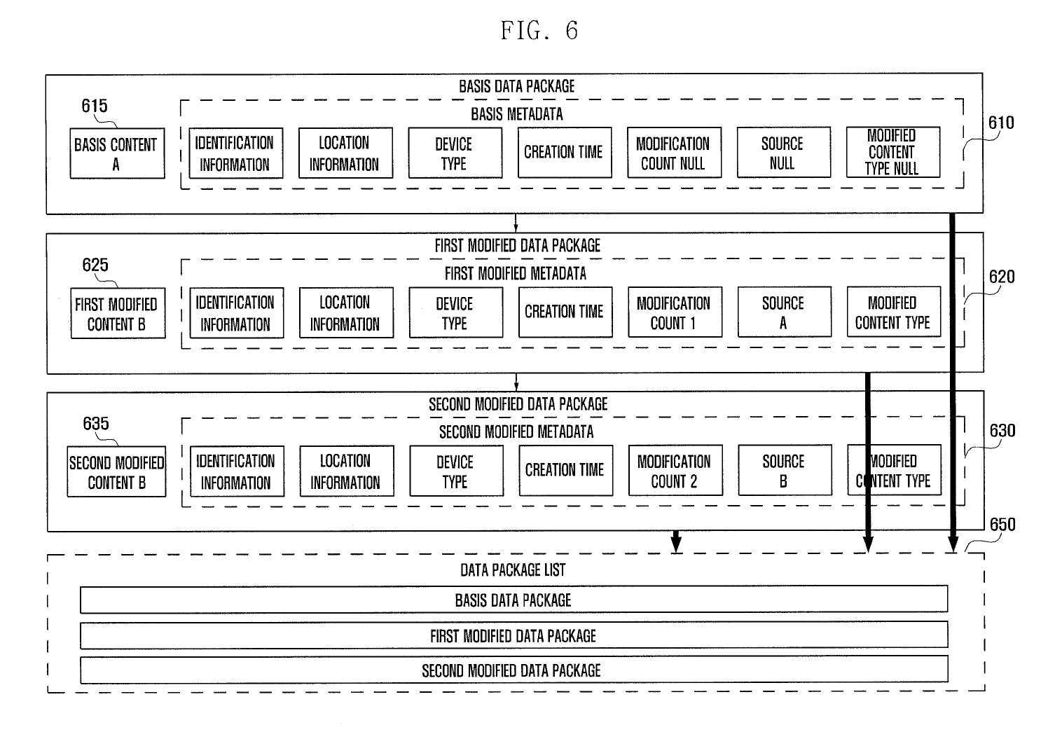

The control unit 260 may further generate data packages according to content sharing processes and create a data package list by combining the generated data packages. As the data package list includes all content and related metadata, the manager may consistently monitor and manage a series of content sharing activities. For example, the data package list may include the generated data packages for each basis content and each of its respective modified content or content otherwise derived from such basis content. Metadata is described in more detail later with reference to FIG. 6.

In addition to generation of content and related metadata, the control unit 260 may specify a device that is permitted to share specific content on the network. That is, the control unit 260 may select a modifier device. Specifically, the control unit 260 may specify at least one device connected to the network server 190 as being a modifier device which is allowed to send a modification request. The control unit 260 may set the number of modifier devices. The control unit 260 may also specify a device indicated by the creator device 201 as being a modifier device.

In the above example, the user A may wish to permit only the user B to share the basis content of A's blog. In this case, the creator device (i.e., notebook computer 201) sends a modifier selection request specifying B's device as a modifier device to the communication unit 250. In response to the modifier selection request, the control unit 260 selects user B's device (i.e., the smartphone 202) as a modifier device. The control unit 260 may grant a right, which permits transmission of a modification request for reading and modifying the corresponding content, to a device (e.g., a smartphone) having user B ID.

The control unit 260 may select a modifier device without separate user intervention. For example, the control unit 260 may permit all devices connected to the network server 190 to share all content, or may permit only a device that has posted a comment to the basis content to share the basis content. In another example, the control unit 260 may analyze the basis content and specify a device that is expected to need the basis content as a modifier device. Selection of a modifier device by the control unit 260 is illustrated later.

After modifier device selection, the communication unit 250 may process a modification request only from those devices which are specified as modifier devices for corresponding content. For example, the communication unit 250 receives a modification request only from a device specified as a modifier device.

The control unit 260 may specify a device that is permitted to read the data package list. That is, the control unit 260 may select a manager device. Specifically, the control unit 260 may select a manager device by granting a right to read the data package list to one of the devices connected to the network server 190. Alternatively, the control unit 260 may select a device indicated by the creator device 201 as being a manager device. Specifically, when a manager selection request is received from the creator device 201, the control unit 260 grants a right to read the data package list to the indicated device. Because the manager device has the right to read the data package list, the manager device may consistently monitor a series of content sharing (e.g., modification) activities. Such monitoring of content sharing activities significantly facilitates content tracking and management.

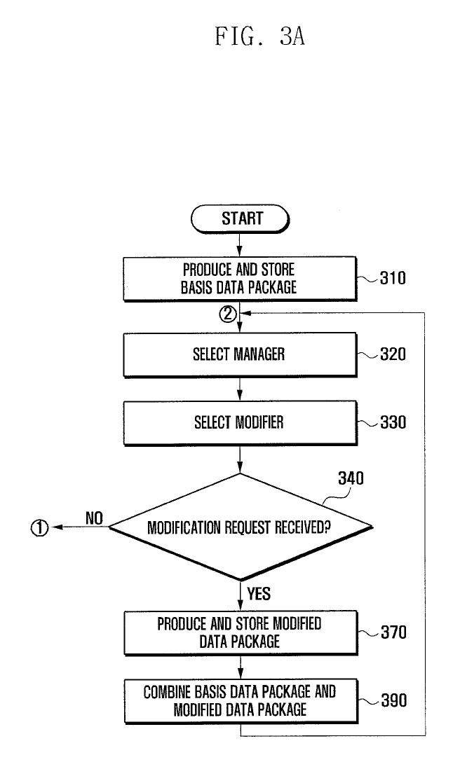

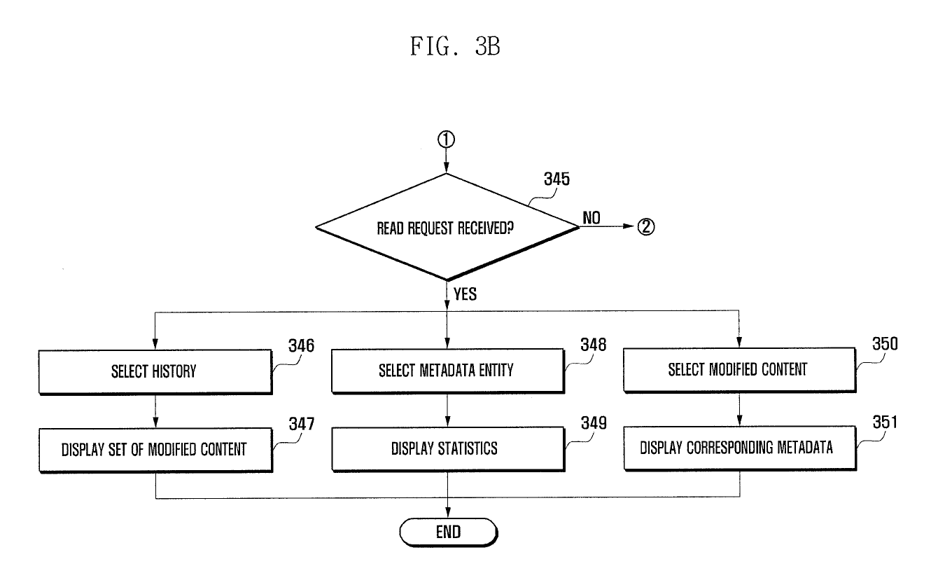

FIG. 3A is a flowchart of a method for content management according to another exemplary embodiment of the present invention. The method of FIG. 3A is described with reference to FIG. 3B to FIG. 6.

Referring to FIG. 3A, if the communication unit 250 of the network server 190 receives a creation request for basis content from the creator device 201, then the control unit 260 creates requested basis content, automatically generates metadata for the basis content (e.g., basis metadata), and stores the basis content and basis metadata as a basis data package in the storage unit 270 at step 310.

The control unit 260 selects a manager device by granting a right to read the metadata package to the manager device at step 320. Step 310 and step 320 may be performed in any order before step 340. The manager device may be specified by the creator device 201. That is, if the communication unit 250 receives a manager selection request from the creator device 201, then the control unit 260 grants a right to read the metadata package to the specified device.

According to some exemplary embodiments of the present invention, a manager device may be provided access to manage and/or to view (i.e., read) the metadata package comprising only a subset of the metadata associated with the corresponding content. In other words, the manager device may be restricted from accessing all of the metadata associated with the corresponding content. As another example, various manager devices may have varying scopes of permissions thus enabling some manager devices to access more of the metadata package than other manager devices are able to access. In another exemplary embodiment of the present invention, the control unit may generate a data package based on the manager device permissions.

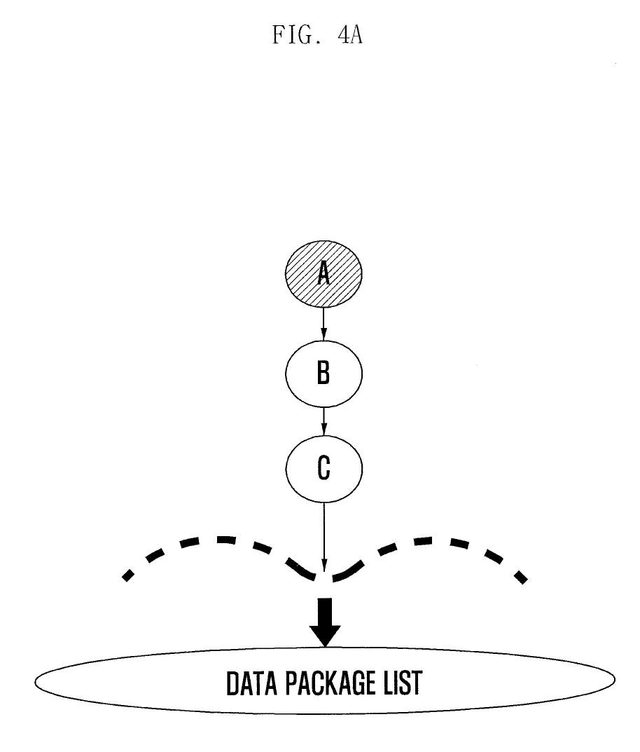

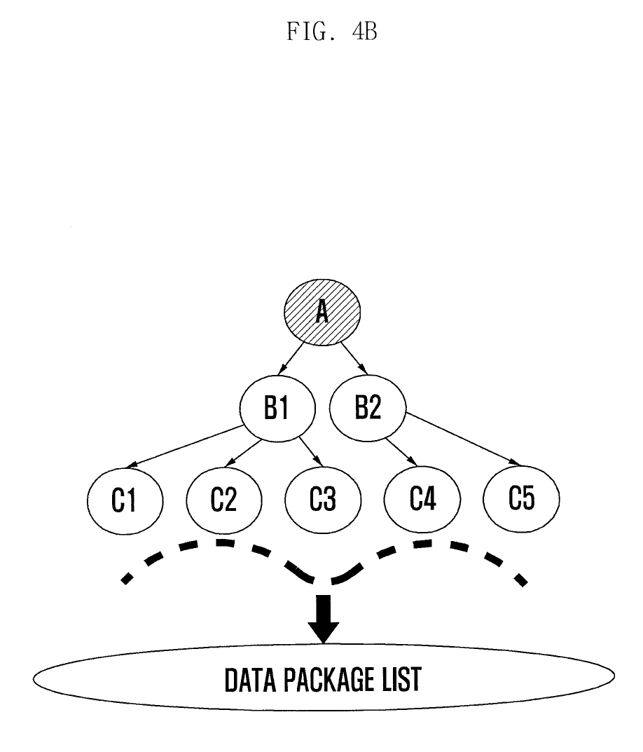

The control unit 260 selects a modifier device that is allowed to transmit a modification request at step 330. Step 310, step 320 and step 330 may be performed in any order before step 340. The modifier device may be specified by the creator device. That is, if the communication unit 250 receives a modifier selection request from the creator device 201, then the control unit 260 grants a right to send a modification request to the specified device. In other embodiments, the manager device may specify the modifier device(s). Selection of a modifier device is illustrated in FIG. 4.

FIG. 4 illustrates appointment of modifiers in a one-to-one or one-to-many manner. FIG. 4A illustrates an appointment of modifiers in a one-to-one manner according to an exemplary embodiment of the present invention. FIG. 4B illustrates an appointment of modifiers in a one-to-many manner according to an exemplary embodiment of the present invention.

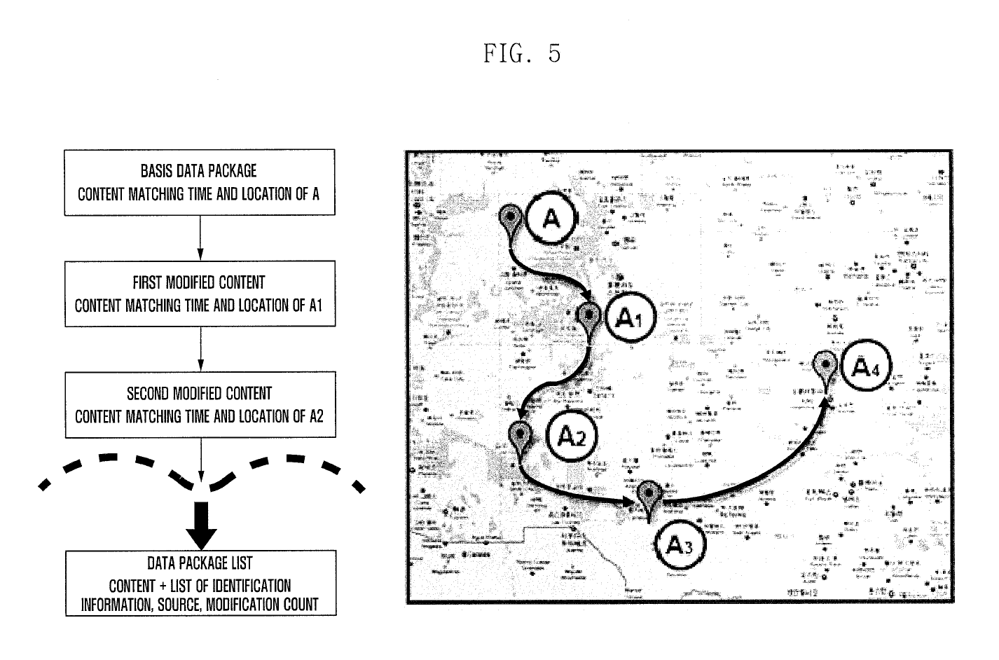

Referring to FIG. 4, the control unit 260 may select one modifier device for a creator device (one-to-one) or select multiple modifier devices for a creator device (one-to-many). In FIG. 4A, the control unit 260 permits data sharing only in a one-to-one framework. In such a framework (i.e., one modifier device for one creator device) the data package list may be structured as a stack or queue. In FIG. 4B, the control unit 260 permits data sharing in a one-to-two or one-to-three way, in which case the data package list may be structured as a tree. Other combinations of creator and modifier devices are possible. One-to-one data sharing is described later in connection with FIG. 5.

Referring back to FIG. 3A, after step 330, the modifier devices 202 to 204 may share (or modify) the basis content through the communication unit 250. This is known to persons skilled in the art, and a description thereof is omitted. At step 340, the control unit 260 checks whether a modification request is received from one of the modifier devices 202 to 204.

If a modification request is received, then the control unit 260 generates modified content and related metadata (e.g., modified metadata), and stores the modified content and modified metadata as a modified data package in the storage unit 270 at step 370.

The control unit 260 combines the generated data packages (e.g., the basis data package and the modified data package) to produce a data package list at step 390. As the data package list includes all content and related metadata, the manager device may consistently monitor and manage a series of content sharing activities. Usage of a data package list is described in more detail later with reference to FIG. 3B.

As described above, distinction between source content and modified content is made by differences between metadata of the source content and that of the modified content. Distinction between basis content and modified content is relative. For example, if modified content is produced by a first modifier on the basis of specific basis content, the modified content may be used by a second modifier as basis content. Hence, the control unit 260 may return from step 390 to step 320 to continue the procedure of content sharing. That is, content sharing and modification may be repeated on the network to produce data packages, and the data package list combining the data packages is updated accordingly.

If a modification request is not received at step 340, the procedure of FIG. 3B may be initiated.

FIG. 3B is a flowchart of a procedure for utilizing a data package list in relation to a method for content management such as, for example, the method illustrated in FIG. 3A according to an exemplary embodiment of the present invention.

Referring to FIG. 3B, the manager device utilizes the data package list. For example, the control unit 260 has granted a right to read the data package list to the manager device at step 320 of FIG. 3A. Because the manager device has a right to read the data package list, the manager device is able to track or manage the source content. For example, with regard to specific modified content, the manager device may have access to monitor, for example, the modification time, a modification location, a modifier, a device used for modification, source content, and modified portions of the source content.

With further reference to FIG. 3B, at step 345, the control unit 260 checks whether a read request is received through the communication unit 250 from the manager device. If a read request is received, then the control unit 260 examines the received read request. As one example, if the read request is related to a modification history at step 346, then the control unit 260 extracts all modified content from the data package list and outputs the extracted modified content to the manager device for display at step 347. For example, the control unit 260 may extract a set of modified content from the data package list stored in the storage unit 270, and transmit the extracted modified content to the manager device through the communication unit 250. As another example, if the read request is related to modifier statistics at step 348, then the control unit 260 extracts statistical data of metadata entities from the data package list and outputs the statistical data to the manager device for display at step 349. As another example, if the read request is related to a modifier of specific content at step 350, then the control unit 260 extracts metadata of the content from the data package list and outputs the extracted metadata to the manager device for display at step 351. As described above, the manager device may obtain statistics from the data package list and utilize the data package list to provide a convenient user interface.

Next, a description is given of modifier selection and generation of basis content, modified content and a data package list with reference to FIGS. 3A and 5.

FIG. 5 illustrates generation of a basis data package, modified data package, and data package list according to an exemplary embodiment of the present invention.

For example, the network server 190 may manage a procedure of torch relay using content and data package list. As shown in FIG. 5, when torch bearers are A, A1, A2, A3 and A4 in sequence, mobile terminals a, a1, a2, a3 and a4 of the torch bearers may be used as devices.

Because the torch bearers are determined in advance, the control unit 260 may specify mobile terminals a1, a2, a3 and a4 as being modifier devices (at step 330 or before step 310 in FIG. 3A). That is, modification requests may be issued only by the mobile terminals a1, a2, a3 and a4. To share torch relay content with all users, the control unit 260 may specify all devices connected to the network server 190 as manager devices (at step 320 or before step 310 in FIG. 3A). In this case, all devices connected to the network server 190 have a right to read the metadata package.

The control unit 260 creates basis content based on information matching the location of the mobile terminal ‘a’ with the passage of time, generates basis metadata containing identification information such as a's IP address and the like, and stores the basis content and basis metadata as a basis data package in the storage unit 270 (step 310 in FIG. 3A).

The control unit 260 receives a modification request from the first modifier device a1 (i.e., the next torch bearer of A) (step 340 in FIG. 3A), and generates first modified content (step 370 in FIG. 3A). Specifically, the first modified content may include information matching the location of the mobile terminal ‘a1’ with the passage of time. As illustrated in this example, the first modified content may not be a result of direct modification of the basis content (e.g., direct modification of the substance of the basis content), but may be modified content by virtue of the metadata of the first modified content being different from that of the basis content. In other words, although the substance of the basis content is not modified, because the metadata of the basis content is modified, the content associated with such modified metadata is considered modified content. The control unit 260 generates first modified metadata containing identification information (e.g., a1's IP address), number of modifications and source content (e.g., basis content), and the control unit 260 stores the content (e.g., the first modified content) and associated metadata in the storage unit 270. The control unit 260 combines the data packages into a data package list (step 390 in FIG. 3A). Thereafter, the above procedure is repeated for the mobile terminals a2, a3 and a4 of the subsequent torch bearers, and the data package list is updated accordingly. All users connected to the network server 190 as managers may share or use torch relay information by reading the data package list.

FIG. 6 illustrates a generated data package list according to an exemplary embodiment of the present invention.

Referring to FIG. 6, a basis data package is indicated by reference symbols 610 and 615. The basis data package includes the basis content 615 and the basis metadata 610. A first modified data package is indicated by reference symbols 620 and 625 (e.g., as comprising a first modified content and first modified metadata), and a second modified data package is indicated by reference symbols 630 and 635 (e.g., as comprising a second modified content and second modified metadata). The control unit 260 combines these data packages to produce a data package list as indicated by reference symbol 650 (step 309 of FIG. 3). Such a data package list may include all information regarding content sharing. For example, each data package includes corresponding metadata. Metadata is composed of information regarding the identity, location, type of a device having sent a creation request or a modification request to the network server 190, and information regarding the creation time, modification count, source and type of the content, or the like. The data package list refers to a set of integrated data obtained by combining all data packages.

A manager device having a right to read the data package list may easily track and manage the original content and manage content sharing activities. For example, by virtue of its access to the data package list, the manager device may be aware of the modification time, modification location, modifier, used device for modification, source content and modified portions of the source content. The manager device may use the data package list to perform statistical analysis or to build a convenient user interface.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for content management using a network server, the method comprising:
producing a basis data package by creating basis content in response to a creation request from a creator and generating basis metadata which describes the basis content;
producing a modified data package by creating modified content utilizing the basis content as a source in response to a modification request from a modifier and generating modified metadata which describes the modified content; and
producing a data package list by combining the basis data package and the modified data package.

2. The method of claim 1, further comprising specifying, before production of the modified data package, a modifier that is permitted to make a modification request.

3. The method of claim 2, wherein the specifying of the modifier comprises specifying at least one device which is indicated by a modifier selection request received from the creator as a modifier.

4. The method of claim 1, further comprising specifying, before production of a modified data package, a manager that is permitted to read the data package list.

5. The method of claim 4, wherein the specifying of the manager comprises specifying at least one device which is indicated by a manager selection request received from the creator as a manager.

6. The method of claim 5, wherein an extent to which the data package list comprises a combination of the basis data package and the modified data package is based on a set of permissions associated with the specified manager.

7. The method of claim 5, wherein the producing of the data package list comprises producing a data package list for each manager.

8. The method of claim 5, wherein the manager has access to read only portions of the data package list for which the manager has associated permissions.

9. The method of claim 1, wherein the basis metadata comprises one or more of creator identification information, creator location information, type information of a device making a creation request for the basis content, and creation time of the basis content, and
wherein the modified metadata comprises one or more of modifier identification information, modifier location information, type information of a device making a creation request for the modified content, creation time of the modified content, source content identifier, and modified content type.

10. The method of claim 1, wherein a scope of the modification request which is permitted by the modifier is based on a set of permissions corresponding to the modifier.

11. An apparatus for content management having a network server that comprises:
a communication unit for receiving creation requests and modification requests from multiple devices, and for sending requested content to at least one device;
a control unit for producing basis content, base metadata, modified content and modified metadata, and for generating a data package list by combining the basis content, base metadata, modified content, and modified metadata; and
a storage unit for storing the basis content, base metadata, modified content, modified metadata, and data package list.

12. The apparatus of claim 11, wherein the control unit specifies at least one device connected to the network server as a modifier device that is permitted to make a modification request.

13. The apparatus of claim 12, wherein the communication unit receives a modifier selection request from a creator device, and the control unit specifies a device indicated by the modifier selection request as the modifier device.

14. The apparatus of claim 11, wherein the control unit specifies at least one device connected to the network server as a manager device that has a right to read the data package list.

15. The apparatus of claim 14, wherein the communication unit receives a manager selection request from a creator device, and the control unit specifies a device indicated by the manager selection request as the manager device.

16. The method of claim 15, wherein the control unit generates the data package list based on a set of permissions associated with the specified manager.

17. The method of claim 15, wherein the control unit generates the data package list for each manager.

18. The method of claim 15, wherein the manager has access to read only portions of the data package list for which the manager has associated permissions.

19. The apparatus of claim 11, wherein the control unit generates the basis metadata comprising one or more of identification information of a creator device, location information of the creator device, type information of the creator device, and creation time of the basis content, and generates the modified metadata comprising one or more of identification information of a modifier device, location information of modified content, source content identifier, and modified content type.

20. A system for managing content, the system comprising:
a plurality of devices; and
a network server that comprises:
a communication unit for receiving creation requests and modification requests from the plurality of devices, and for sending requested content to at least one of the plurality of devices;
a control unit for producing basis content, base metadata, modified content and modified metadata, and for generating a data package list by combining the basis content, base metadata, modified content, and modified metadata; and
a storage unit for storing the basis content, base metadata, modified content, modified metadata, and data package list.
